(19) United States
(12) Patent Application Publication
(10) Pub. No.: US 2026/0212601 A1
(43) Pub. Date: Jul. 23, 2026

(54) DEVICE AND METHOD FOR GENERATING THREE-DIMENSIONAL MESH DATA

(71) Applicant: Electronics and Telecommunications Research Institute, Daejeon (KR)

(72) Inventors: Inhak Joo, Daejeon (KR); In Sung Jang, Daejeon (KR)

(21) Appl. No.: 19/456,769

(22) Filed: Jan. 22, 2026

(30) Foreign Application Priority Data
Jan. 23, 2025 (KR) 10-2025-0010045

(51) Int. Cl. G06T 17/20

(52) U.S. Cl. CPC G06T 17/20

(57) ABSTRACT

Provided are a device and method for generating three-dimensional (3D) mesh data. The device includes a memory storing digital surface model (DSM) 3D mesh data and a processor functionally connected to the memory. The processor detects a bottom surface of each individual building using a height value in the DSM 3D mesh data, generates 3D mesh data of the individual building on the basis of a 3D space corresponding to the bottom surface, and stores the 3D mesh data of the individual building in the memory.

### CROSS-REFERENCE TO RELATED APPLICATION

This application claims priority to and the benefit of Korean Patent Application No. 10-2025-0010045, filed on January 23, 2025, the disclosure of which is incorporated herein by reference in its entirety.

### BACKGROUND

### 1. Field of the Invention

Various exemplary embodiments disclosed in the present document relate to a three-dimensional (3D) spatial information technology.

### 2. Discussion of Related Art

Three-dimensional (3D) spatial information technology, the foundation of 3D geographic information system (GIS), is a technology for representing two-dimensional (2D) location information similarly to the real world by adding height, texture images, attributes, etc., to the 2D location information. 3D spatial information is used to establish the foundation for public sectors, such as urban development planning, disaster prevention, traffic control, and environment, and related industries.

Related art of 2D spatial information provides buildings and roads in the form of flat 2D maps. However, 3D spatial information may be visualized (expressed or displayed) by be projecting it in a form closely resembling the real world, making it highly utilizable. An example of 3D spatial information is a digital surface model (DSM) including terrain elevation, altitude, and curvature.

DSM data is topographic data representing the heights of the highest points on the Earth’s surface, recording altitude information of all surface features (e.g., building, trees, and other structures). DSM data is represented as a 2D grid including the location (planar coordinates) of each point and the height of the highest point on the surface (altitude information) or a 3D mesh model.

### SUMMARY OF THE INVENTION

According to such digital surface model (DSM) data, a wide range of area is merely constructed as a single object, and various features within the area are hardly distinguished. More specifically, most DSM data is constructed by treating data of a large area as a single object in which various features such as buildings, roads, trees, etc., are not distinguished and buildings are not distinguished from each other. Therefore, DSM data has limitations in practical use such as difficulty in checking feature-level information or updating feature-level data. Consequently, it is difficult to utilize or serve DSM data as a three-dimensional (3D) spatial map.

A 3D spatial information service device may generate 3D data in the form of a mesh model including 3D terrain and features (hereinafter “DSM 3D mesh data”) using altitude information at each coordinate point on a map.

The spatial information service device may display 3D spatial information on the basis of DSM 3D mesh data. In this case, when the spatial information service device displays the 3D mesh data without any change, the 3D spatial information may appear at first glance to resemble the real world. However, the 3D spatial information is not distinguished in units of features (e.g., buildings) existing on the ground. Accordingly, it is not possible to provide feature-specific services such as feature selection, and querying or analyzing information related to a selected feature, on a screen of the spatial information service device. Also, partial updates are not possible. Accordingly, even when there are changes to real-world features such as new construction or demolition of buildings, it is necessary to reconstruct data of the entire area. Therefore, the spatial information service device that represents 3D spatial information on the basis of original DSM 3D mesh data has difficulty in rapidly responding to changes in the real world.

Various embodiments disclosed in the present document provide a 3D mesh data generation device and method for generating 3D mesh data in which features are distinguishable, from DSM 3D mesh data in which features are indistinguishable.

According to an embodiment disclosed in the present document, there is provided a device for generating 3D mesh data including a memory storing DSM 3D mesh data and a processor functionally connected to the memory. The processor detects a bottom surface of each individual building using a height value in the DSM 3D mesh data, generates 3D mesh data of the individual building on the basis of a 3D space corresponding to the bottom surface, and stores the 3D mesh data of the individual building in the memory.

According to an embodiment disclosed in the present document, there is provided a method of generating 3D mesh data using at least one processor, the method including detecting a bottom surface of each individual building using a height value of DSM 3D mesh data, detecting a 3D space of the individual building including the bottom surface and side surfaces perpendicular to the bottom surface, generating 3D mesh data of the individual building on the basis of the 3D space, and storing the 3D mesh data of the individual building.

According to another embodiment disclosed in the present document, there is provided a device for generating 3D mesh data including a communication module configured to communicate with a user terminal and a processor functionally connected to the communication module. The processor acquires DSM 3D mesh data through the communication module in accordance with a request of the user terminal, detects a bottom surface of each individual building using a height value in the DSM 3D mesh data, detects a 3D space of the individual building including the bottom surface and side surfaces perpendicular to the bottom surface, generates 3D mesh data of the individual building on the basis of the 3D space, and provides the 3D mesh data of the individual building to the user terminal through the communication module.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a hardware configuration diagram of a device for generating three-dimensional (3D) mesh data according to an embodiment;

FIG. 2 is a functional configuration diagram of the device for generating 3D mesh data according to the embodiment;

FIG. 3 is an example of a 3D view of original digital surface model (DSM) 3D mesh data according to the embodiment;

FIG. 4 is an example of a two-dimensional (2D) view of some of original DSM 3D mesh data according to the embodiment;

FIG. 5 shows an example of calculating a lowest point according to the embodiment;

FIG. 6 shows an example of detecting a building bottom surface according to the embodiment;

FIG. 7 shows an example of expanding a building bottom surface according to the embodiment;

FIG. 8 shows an example of detecting a 3D space of a building according to the embodiment;

FIG. 9 shows an example of detecting a 3D space of the building according to the embodiment;

FIG. 10 three-dimensionally shows an example of detecting a 3D space of the building according to the embodiment;

FIG. 11 shows an example of generating DSM 3D mesh data excluding a 3D space of the building according to the embodiment.

FIG. 12 shows an example of a process of generating a bottom surface of another building according to the embodiment;

FIG. 13 is a schematic flowchart of a method of generating 3D mesh data according to an embodiment;

FIG. 14A and 14B are a detailed flowchart of the method of generating 3D mesh data according to the embodiment;

FIG. 15 is a block diagram of a server-type device for generating 3D mesh data according to an embodiment;

FIG. 16 shows an example of separating individual buildings from 3D mesh data according to an embodiment;

FIG. 17 shows an example of 3D mesh data in units of individual buildings according to an embodiment; and

FIG. 18 shows an example of providing building information on the basis of 3D mesh data of an individual building according to an embodiment.

In relation to the description of drawings, like reference numerals may be used for like components.

### DETAILED DESCRIPTION OF EXEMPLARY EMBODIMENTS

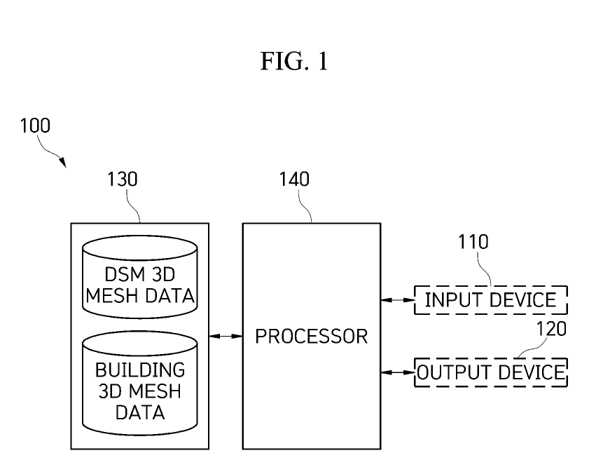

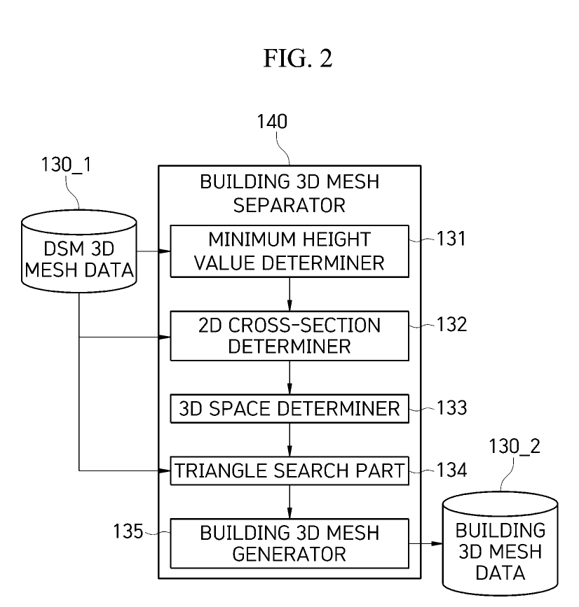

FIG. 1 is a hardware configuration diagram of a device for generating three-dimensional (3D) mesh data according to an embodiment, and FIG. 2 is a functional configuration diagram of the device for generating 3D mesh data according to the embodiment.

Referring to FIG. 1, a device 100 for generating 3D mesh data according to the embodiment may include an input device 110, an output device 120, a memory 130, and a processor 140. According to the embodiment, some components of the device 100 for generating 3D mesh data may be omitted, or additional components may be further included. For example, at least one of the input device 110 and the output device 120 may be omitted. As another example, the input device 110 and the output device 120 may be provided in an external electronic device (user terminal) such that the device 100 for generating 3D mesh data can interact with a user through a communication module using the input and output devices. Also, some of the components of the device 100 for generating 3D mesh data may be combined into one entity, which may perform the same function as the corresponding components before the combination.

The memory 130 may include various forms of volatile memories or non-volatile memories. For example, the memory 130 may include a read-only memory (ROM) and a random access memory (RAM). According to the embodiment, the memory 130 may be located inside or outside the processor 140, and connected to the processor 140 in various already-known ways.

The memory 130 may store various data used by at least one component (e.g., the processor 140) of the device 100 for generating 3D mesh data. The data may include, for example, software and input data or output data for instructions related to the software. For example, the memory 130 may store at least one instruction and data for generating 3D mesh data of buildings from original DSM 3D mesh data. The memory 130 may store the original DSM 3D mesh data in a first region 130_1 and store 3D mesh data of buildings in a second region 130_2.

The processor 140 may control at least one other component (e.g., hardware or software component) of the device 100 for generating 3D mesh data and perform various data processing or computation. For example, the processor 140 may include at least one of a central processing unit (CPU), a microprocessor, an application processor, an application-specific integrated circuit (ASIC), and a field programmable gate array (FPAG) and may have a plurality of cores. According to the embodiment, the processor 140 may acquire the DSM 3D mesh data from the first region 130_1 of the memory 130, detect a bottom surface of a building from the original DSM 3D mesh data, and generate 3D mesh data of the individual building on the basis of a 3D space corresponding to the bottom surface. The processor 140 may store the 3D mesh data of the individual building in the second region 130_2 of the memory 130.

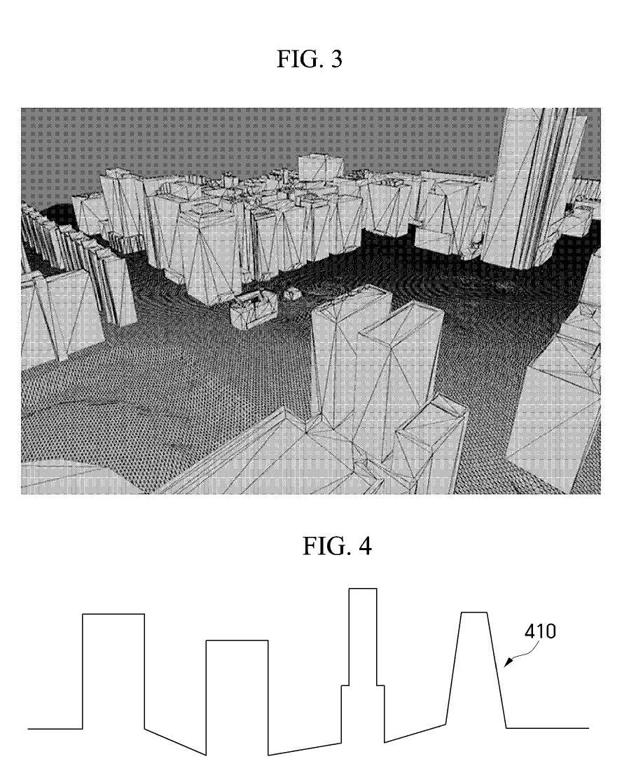

According to the embodiment, the processor 140 may include a minimum height value determiner 131, a two-dimensional (2D) cross-section determiner 132, a 3D space determiner 133, a triangle search part 134, and a building 3D mesh generator 135. The minimum height value determiner 131, the 2D cross-section determiner 132, the 3D space determiner 133, the triangle search part 134, and the building 3D mesh generator 135 may be hardware modules or software modules included in the processor 140 or executed by the processor 140. Embodiments will be described below with reference to FIGS. 3 to 12.

FIG. 3 is an example of a 3D view of original DSM 3D mesh data according to the embodiment.

Referring to FIG. 3, the DSM 3D mesh data may be composed of triangles such as a triangulated irregular network (TIN). The original DSM 3D mesh data is 3D data of terrain including features on the ground and is referred to as 3D modeling data. According to various embodiments, the original DSM 3D mesh data may be generated through photogrammetry using an unmanned aerial vehicle. As shown in FIG. 3, original DSM 3D mesh data may be represented similarly to the real world.

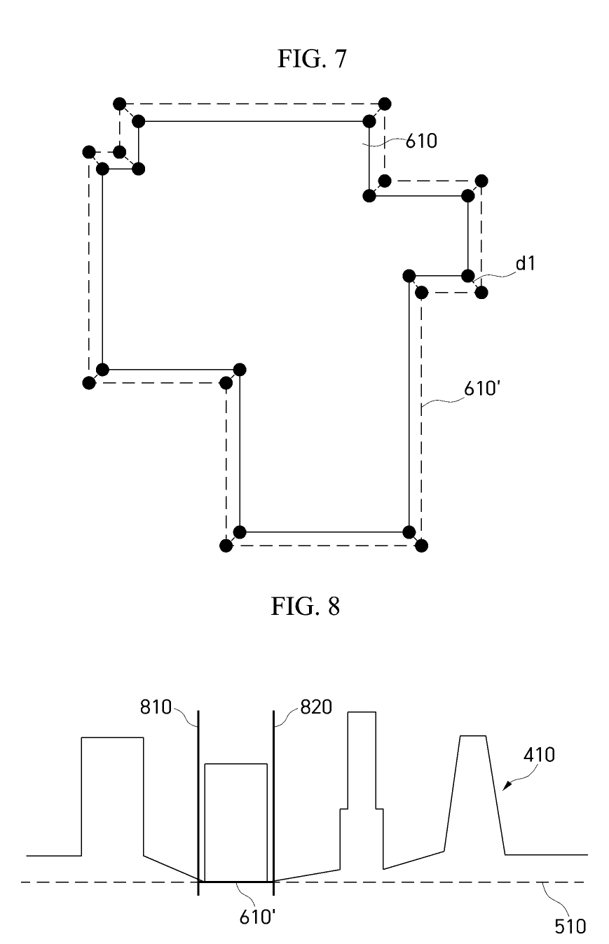

In FIGS. 4 to 9, FIG. 11, and FIG. 12, some of DSM 3D mesh data is simplified and represented as 2D cross-section views to aid in description and understanding. The drawings other than FIG. 7 are described as 2D cross-sections viewed from a side.

Referring to FIG. 4, DSM 3D mesh data is represented as a single object without distinguishing between features (buildings, structures, and vehicles) and a height of the ground without any feature. In other words, original DSM 3D mesh data 410 is formed as one 3D model object whose size corresponds to a local scope of the data. The original DSM 3D mesh data 410 is solid data corresponding to three dimensions, but in FIGS. 4 to 9, FIG. 11, and FIG. 12, will be described on the basis of 2D shapes viewed from a side or above.

According to the embodiment, the processor 140 may acquire the original DSM 3D mesh data 410 of a target from which buildings will be separated, from the first region 130_1 of the memory 130.

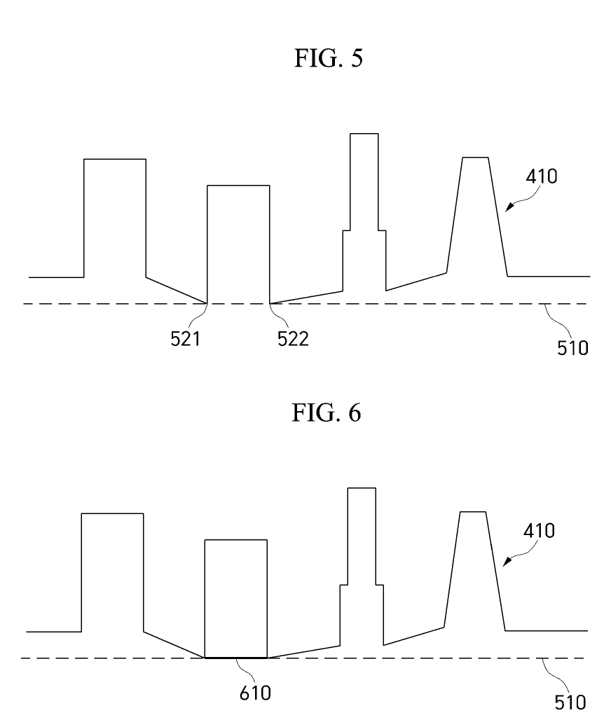

FIG. 5 shows an example of calculating a lowest point according to the embodiment.

Referring to FIG. 5, the processor 140 (the minimum height value determiner 131) may detect a height value (minimum height value) of the lowest-level point (hereinafter, “lowest point”) in acquired original DSM 3D mesh data by referring to altitude information of the original DSM 3D mesh data. For example, the processor 140 may detect a minimum height value (lowest points 521 and 522) in 3D coordinate values of all triangles constituting the original DSM 3D mesh data. Also, the processor 140 may form a virtual horizontal plane 510 (see a broken line at the bottom) that has the minimum height value and is parallel to a horizon.

FIG. 6 shows an example of detecting a building bottom surface according to the embodiment.

Referring to FIG. 6, according to the embodiment, the processor 140 (the 2D cross-section determiner 132) may detect a surface that has four or more points (vertices of triangles) in the horizontal plane 510 as vertices, as a building bottom surface 610 (see a thick solid line). Since FIG. 6 is a 2D cross-sectional view, the building bottom surface 610 is shown as a line but actually corresponds to a 2D plane. For example, the processor 140 increases a height value of the horizontal plane 510 stage by stage from the minimum height value until there are four or more vertices at or lower than the horizontal plane 510. The processor 140 may detect a plane acquired by connecting the found four or more vertices. The found four or more vertices may have identical or similar height values within a margin of error. The error may be experimentally determined using vertices constituting the same plane.

According to the embodiment, the processor 140 may selectively detect a building bottom surface on the basis of an area of the detected plane. For example, the processor 140 may calculate the area of the detected plane and compare the calculated area with a threshold area. When the calculated area is greater than or equal to the threshold area, the processor 140 may detect the detected plane as the building bottom surface 610 (see the thick solid line). The threshold area may be determined on the basis of, for example, actual bottom surface areas of buildings in the real world.

According to the embodiment, the processor 140 may calculate mesh data of the detected building bottom surface 610 using triangles constituting the building bottom surface 610.

FIG. 7 shows an example of expanding a building bottom surface according to the embodiment, and FIG. 8 shows an example of detecting a 3D space of a building according to the embodiment. In FIG. 7, DSM 3D mesh data is shown as a 2D cross-section viewed from above.

Referring to FIG. 7, the processor 140 (the 2D cross-section determiner 132) may expand the building bottom surface outward by a threshold distance d1 and, as shown in FIG. 8, may form polygonal side surfaces 810 and 820 perpendicular to the horizon from edges of an expanded bottom surface 610’ outside the building. The threshold distance d1 may be determined in accordance with protruding parts of the building. For example, the threshold distance d1 may be 1 m. In this way, according to the embodiment, the polygonal side surfaces 810 and 820 for expanding the bottom surface outward by the threshold distance and separating the building are determined. Accordingly, the protruding parts of the building are not omitted but included to detect a 3D space of the building.

FIG. 9 shows an example of detecting a 3D space of the building according to the embodiment.

Referring to FIG. 9, the processor (the 3D space determiner 133) 140 may determine a 3D part surrounded by 2D areas (the polygonal side surfaces 810 and 820 and the expanded bottom surface 610’) of the building as a 3D space of the building. The processor 140 (the triangle search part 134) may select triangles included in the 3D space of the building. The processor 140 may perform a process of detecting the triangles included in the 3D space from the original DSM 3D mesh data through known geometric calculation.

The processor 140 (the building 3D mesh generator 135) may generate 3D mesh data of the building by configuring the selected triangles (see a hatched area of FIG. 9). According to the embodiment, the original DSM 3D mesh data does not include triangle data of the bottom surface 610 of the building, but 3D mesh data of the building detected according to the embodiment may include triangle data (mesh data) of the bottom surface 610 of the building.

Subsequently, the processor 140 may further detect other bottom surfaces of the building by connecting four or more vertices (having identical or similar height values within the margin of error) while increasing a height value of the horizontal plane 510 stage by stage. The processor 140 may repeat a process of detecting mesh data of the building from the original DSM 3D mesh data up to the highest height of the original DSM 3D mesh data. Accordingly, the processor 140 may separately generate 3D mesh data of a plurality of buildings included in the original DSM 3D mesh data. For example, the processor 140 may separately generate 3D mesh data of all the buildings or some buildings included in the original DSM 3D mesh data.

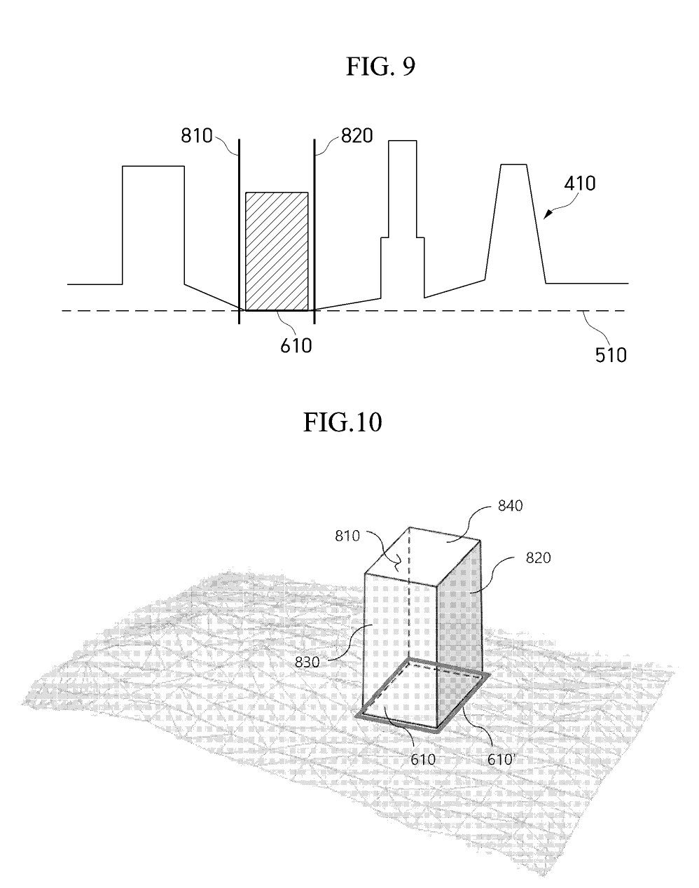

FIG. 10 three-dimensionally shows an example of a process of detecting a 3D space of the building described above with reference to FIGS. 8 and 9.

The processor 140 may detect the bottom surface 610 of the building acquired by connecting the four or more points having an identical or lower height value than the horizontal plane 510 and then detect the expanded bottom surface 610’ by expanding the bottom surface 610 by the threshold distance d1. The processor 140 may form exterior polygonal side surfaces 810, 820, 830, and 840 of the building that come into contact with each of edges of the bottom surface 610 and are perpendicular to the horizon, on the expanded bottom surface 610’.

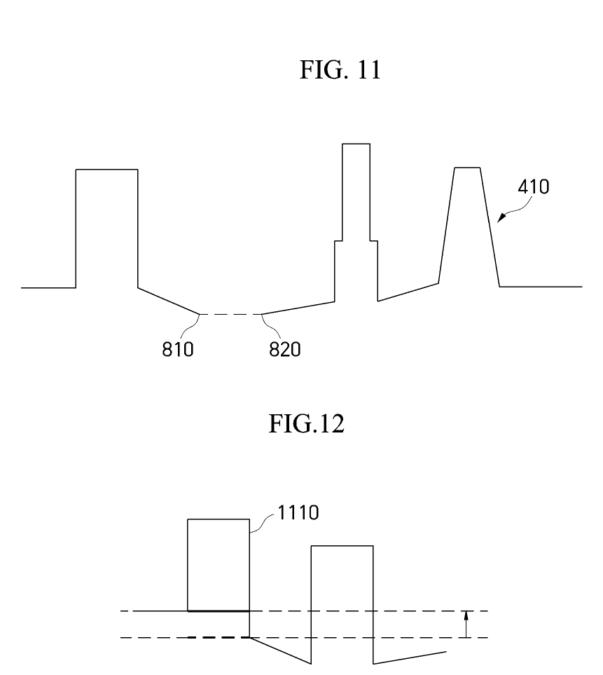

FIG. 11 shows an example of generating DSM 3D mesh data excluding a 3D space of the building according to the embodiment.

Referring to FIG. 11, the processor 140 (the building 3D mesh generator 135) may separate the triangles included in the 3D space of the building and then generate DSM 3D mesh data excluding 3D mesh data of the building. For example, the processor 140 may generate the DSM 3D mesh data excluding the 3D mesh data of the building by connecting ground surfaces that come into contact with the 3D space of the building. Also, the processor 140 may detect a surface generated by connecting the ground surfaces as the foregoing bottom surface of the building and obtain 3D mesh data using triangles in the same manner as in the process of expanding the bottom surface.

FIG. 12 shows an example of a process of generating a bottom surface of another building according to the embodiment.

Referring to FIG. 12, the processor 140 may detect a surface (see a horizontal thick solid line of FIG. 12) acquired by connecting four or more vertices (having identical or similar height values within the margin of error) while increasing stage by stage a height value of a horizontal plane for detecting a bottom surface. For example, a ground surface on which a building 1110 is located may have a plurality of vertices among which three or less vertices may be relatively low, and other vertices may be relatively high. In this case, the processor 140 may detect a bottom surface of the building 1110 more accurately by detecting a surface acquired by connecting four or more vertices. In addition, a horizontal broken line part of FIG. 12 has only three or less vertices and thus may not be detected as a cross section.

According to various embodiments, buildings generally have the bottom surface with the largest area, but a bottom surface of a building may have a smaller area than floor surfaces at upper levels. Alternatively, a bottom surface of a building may be sloped due to the ground. In this case, an error may occur in detecting the bottom surface of the building.

In this regard, since the processor 140 repeats a process of separating building 3D mesh data from the minimum height value to the maximum height value of the original DSM 3D mesh data, it is possible to correct errors during the repeated process. For example, when another bottom surface is detected at a location of a previously separated building, the processor 140 may determine that the previous building separation is erroneous. The processor 140 may correctively generate 3D mesh data of the corresponding building on the basis of the detected other bottom surface. To this end, the processor 140 may store history information (e.g., 3D space information of the building) of building separation and, when a new bottom surface is detected, may compare the new bottom surface with the history information.

According to various embodiments, the processor 140 may generate remaining DSM 3D mesh data (hereinafter “DSM ground 3D mesh data”) from which the building is separated by deleting 3D mesh data of the building separated from the original DSM 3D mesh data and store the DSM ground mesh data in the second region of the memory 130. Subsequently, the processor 140 may display the DSM ground mesh data and building-specific 3D mesh data together and, when a building is selected, may provide a function of querying and editing the selected building. For example, the processor 140 may provide a service such as deleting the selected building and replacing the deleted building with 3D mesh data of another building.

According to various embodiments, the processor 140 may separate 3D mesh data of a building further using at least one piece of building information among building outer-line information (building location information). For example, the processor 140 may check a position of each feature in the DSM 3D mesh data from 2D map data including building outer-line information. The processor 140 may detect a bottom surface of each building at positions of buildings having an area greater than or equal to the threshold area among the checked features. Subsequently, the processor 140 may generate 3D mesh data of the building from the detected bottom surface by configuring exterior polygonal side surfaces of the building and determining a 3D space of the building in the same manner as in the above-described process. Similarly, the processor 140 may detect the 3D space of the building on the basis of location information (e.g., latitude and longitude coordinates) of the building and generate 3D mesh data of the building.

According to various embodiments, when processing DSM 3D mesh data, the processor 140 may check heights of the ground without features by referring to digital elevation model (DEM) data of the same area only including the heights of the ground and detect a bottom surface of each building using the checked ground heights.

As described above, the device 100 for generating 3D mesh data according to the embodiment can rapidly generate 3D mesh data of a building by distinguishing and separating buildings on the basis of DSM 3D mesh data without additional data. Additionally or alternatively, the device 100 for generating 3D mesh data according to the embodiment can generate 3D mesh data of buildings more accurately by distinguishing and separating buildings on the basis of DSM 3D mesh data using additional data.

Also, the device 100 for generating 3D mesh data according to the embodiment can convert DSM data in which a large area is configured as a single object into mesh data and then divide the mesh data into objects, thus supporting provision of a 3D spatial information service in building units.

Further, the device 100 for generating 3D mesh data according to the embodiment can generate 3D mesh data in which individual buildings are separated, thus enabling data management in building units. In addition, when a building is added or removed (or changed) (due to new construction, demolition, rebuilding, etc.), the device 100 for generating 3D mesh data, according to the embodiment, may generate DSM 3D mesh data regarding the changed building only by adding, removing, or changing the corresponding building so it can be more efficient than the conventional DSM 3D mesh data update method, which reconstructs the whole DSM 3D mesh data of an entire large area.

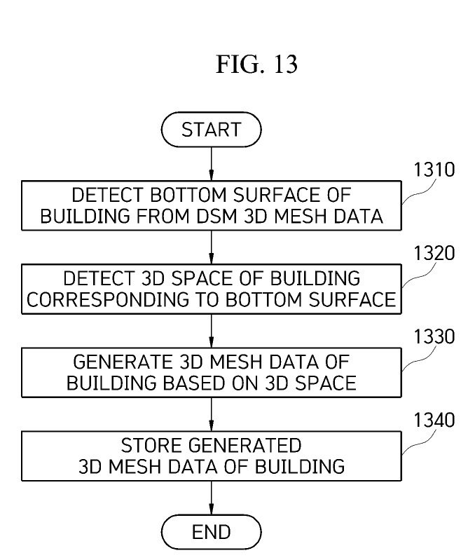

FIG. 13 is a schematic flowchart of a method of generating 3D mesh data according to an embodiment.

Referring to FIG. 13, in operation 1310, the device 100 for generating 3D mesh data may detect a bottom surface of each individual building from DSM 3D mesh data.

In operation 1320, the device 100 for generating 3D mesh data may detect a 3D space corresponding to the bottom surface.

In operation 1330, the device 100 for generating 3D mesh data may generate 3D mesh data of the individual building on the basis of the 3D space.

In operation S1340, the device 100 for generating 3D mesh data may store the 3D mesh data of the individual building.

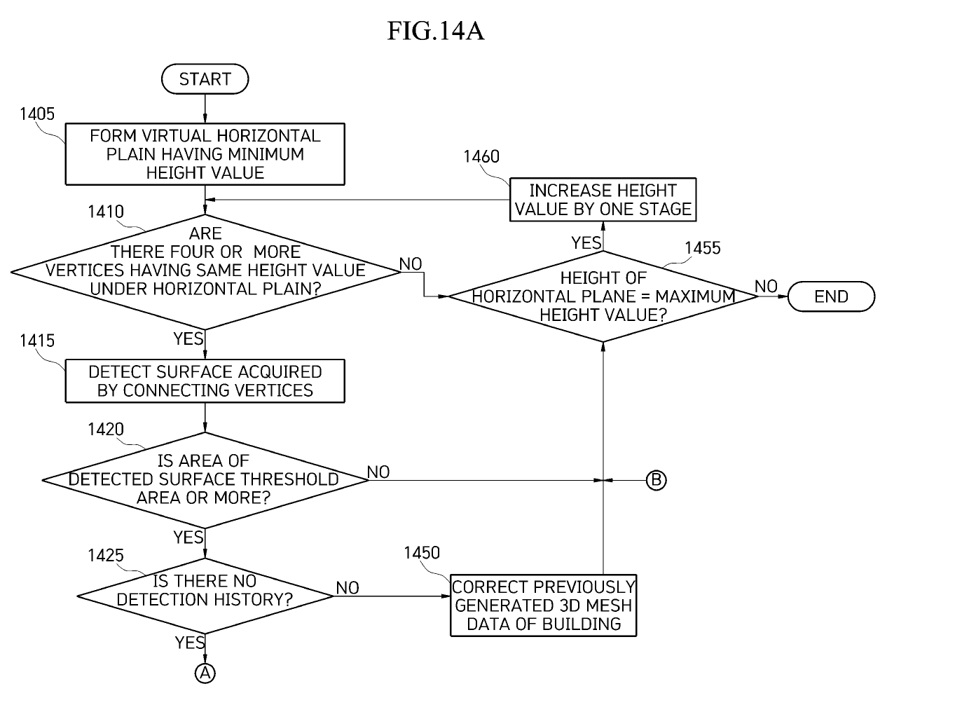

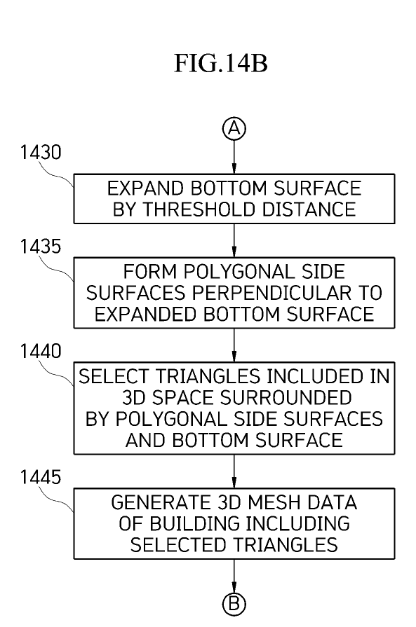

FIG. 14A and 14B are a detailed flowchart of the method of generating 3D mesh data according to the embodiment.

Referring to FIG. 14A and 14B, in operation 1405, the device 100 for generating 3D mesh data may form a virtual horizontal plane having the minimum height value in DSM 3D mesh data.

In operation 1410, the device 100 for generating 3D mesh data may determine whether there are four or more vertices having identical or similar height values at the height of the horizontal plane or less. The similar height values may be height values identical to each other within a margin of error.

When it is determined in operation 1410 that there are four or more vertices having identical or similar height values at the height of the horizontal plane or less, in operation 1415, the device 100 for generating 3D mesh data may detect a surface acquired by connecting the vertices having the identical or similar height values.

When the surface acquired by connecting the vertices having the identical or similar height values is detected in operation 1415, in operation 1420, the device 100 for generating 3D mesh data may verify whether an area of the detected surface is a threshold area or more.

When it is verified in operation 1420 that the area of the detected surface is the threshold area or more, in operation 1425, the device 100 for generating 3D mesh data may determine the detected surface as a building bottom surface and determine whether the detected bottom surface has ever been detected.

When it is determined in operation 1425 that the detected building bottom surface has never been detected, the device 100 for generating 3D mesh data may expand the bottom surface by a threshold distance in operation 1430.

In operation 1435, the device 100 for generating 3D mesh data may form polygonal side surfaces perpendicular to the expanded building bottom surface.

In operation 1440, the device 100 for generating 3D mesh data may select triangles existing in a 3D space surrounded by the polygonal side surfaces and the bottom surface.

In operation 1445, the device 100 for generating 3D mesh data may separately generate 3D mesh data of a building composed of the selected triangles only. When the 3D mesh data of the building is separately generated, the device 100 for generating 3D mesh data may generate remaining DSM 3D mesh data by separating the 3D mesh data of the building from the DSM 3D mesh data in operation 1450.

When it is determined in operation 1410 that there are not four or more vertices having identical or similar height values at the height of the horizontal plane or less, or it is determined in operation 1420 that the area of the detected surface is less than threshold area, the device 100 for generating 3D mesh data may verify whether the height of the horizontal plane is less than the maximum height in operation 1455. When it is determined in operation 1455 that the height of the horizontal plane is less than the maximum height, the device 100 for generating 3D mesh data may increase the height value of the horizontal plane by one stage and return to operation 1410 to repeat generating 3D mesh data of the building.

When the area of the detected surface is the threshold area or more but it is determined in operation 1425 that the detected surface overlaps a bottom surface of a previously separated building, the device 100 for generating 3D mesh data may determine that 3D mesh data of the previously separated building is erroneous. Assuming that the detected surface as the bottom surface of the building, the device 100 for generating 3D mesh data may correct the 3D mesh data of the previously separated building.

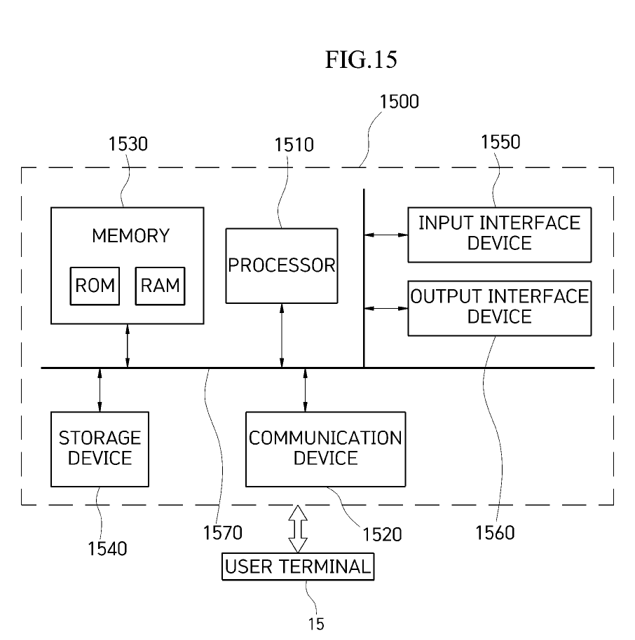

FIG. 15 is a block diagram of a server-type device for generating 3D mesh data according to an embodiment.

Referring to FIG. 15, a server-type device 1500 for generating 3D mesh data may include at least one of a processor 1510, a memory 1530, an input interface device 1550, an output interface device 1560, and a storage device 1540 that communicate via a bus 1570. Also, the server-type device 1500 for generating 3D mesh data may further include a communication device 1520 coupled to a network. The processor 1510 may be a CPU or a semiconductor device that executes instructions stored in the memory 1530 or the storage device 1540. The memory 1530 or the storage device 1540 may include various forms of volatile or non-volatile storage media. For example, the memory 1530 may include a ROM and a RAM. According to the embodiment, the memory 1530 may be located inside or outside the processor 1510, and the memory 1530 may be connected to the processor 1510 in various known ways.

According to the embodiment, the processor 1510 may acquire DSM 3D mesh data from the memory 1530 in accordance with a request received from a user terminal 15 through the communication device 1520. The processor 1510 may detect a bottom surface of each individual building from the DSM 3D mesh data, generate 3D mesh data of the individual building on the basis of a 3D space corresponding to the bottom surface, and provide the 3D mesh data of the individual building to the user terminal 15 through the communication device 1520.

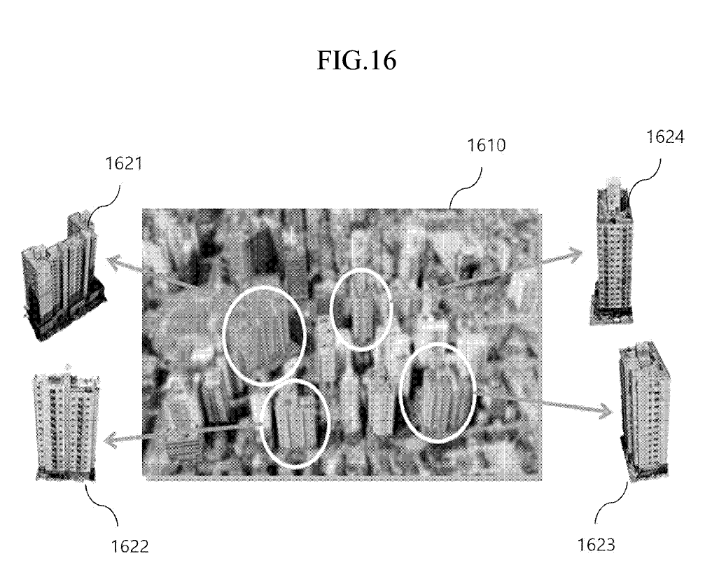

FIG. 16 shows an example of separating individual buildings from 3D mesh data according to an embodiment.

Referring to FIG. 16, the device 100 for generating 3D mesh data may generate 3D mesh data 1621, 1622, 1623, and 1624 of each of desired individual buildings from original DSM 3D mesh data 1610 constructed by treating data of a large area including a plurality of buildings as a single object.

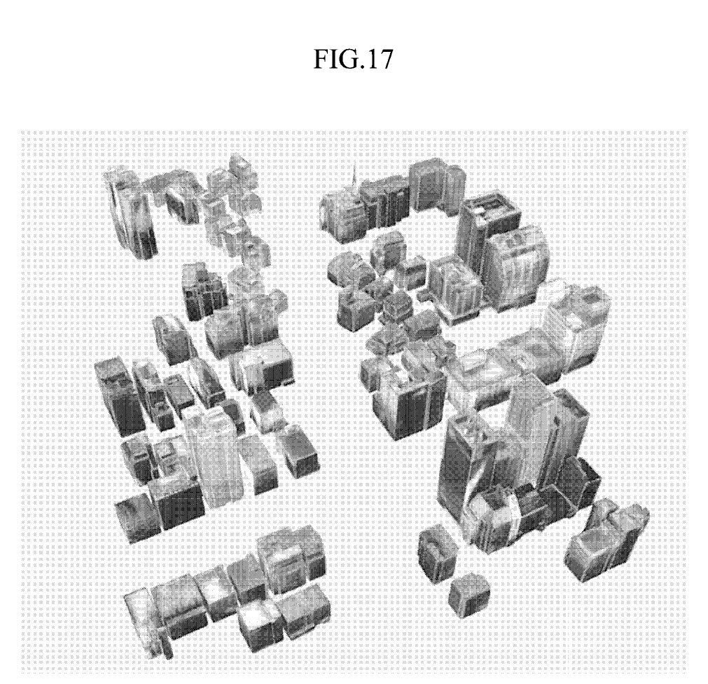

FIG. 17 shows an example of 3D mesh data in units of individual buildings according to an embodiment.

Referring to FIG. 17, 3D mesh data of individual buildings may be modeled or displayed to include only mesh data of a desired building within a single screen. Such a display may be effectively utilized in 3D spatial information service including urban planning.

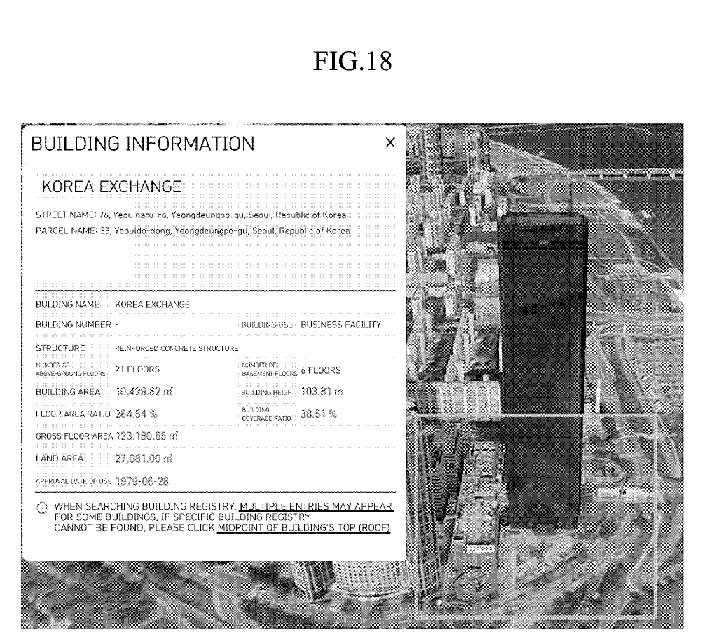

FIG. 18 shows an example of providing building information on the basis of 3D mesh data of an individual building according to an embodiment.

Referring to FIG. 18, when a 3D mesh data object corresponding to a specific building is selected, the device 100 for generating 3D mesh data or a device (not shown) for providing a service on the basis of 3D mesh data of each individual building may provide information related to the building.

It is to be understood that various embodiments of the present document and terms used in the embodiments are not intended to limit technological features set forth herein to specific embodiments and include various modifications, equivalents, or substitutions for the embodiments. With regard to the description of the drawings, similar reference numerals may be used to refer to similar or related components. A singular form of a noun corresponding to an item may include one or more of the items unless the relevant context clearly indicates otherwise. As used herein, each of phrases such as “A or B,” “at least one of A and B,” “at least one of A or B,” “A, B, or C,” “at least one of A, B, and C,” and “at least one of A, B, or C” may include any one of or all possible combinations of items enumerated together in a corresponding one of the phrases. Terms such as “1^{st}” and “2^{nd}” or “first” and “second” may be used to simply distinguish a corresponding component from another, and do not limit the components in other aspects (e.g., importance or order). When a (e.g., first) component is referred to, with or without the term “functionally” or “communicatively,” as “coupled” or “connected” to another (e.g., second) component, it means that the first component may be coupled to the second component directly (e.g., by wire), wirelessly, or via a third component.

As used herein, the term “module” may include a unit implemented in hardware, software, or firmware, and may be interchangeably used with other terms, for example, “logic,” “logic block,” “part,” or “circuitry.” A module may be a single integral component or a minimum unit or part thereof that performs one or more functions. For example, according to an embodiment, a module may be implemented in the form of an ASIC.

Various embodiments of the present document may be implemented as software (e.g., a program) including one or more instructions stored in a storage medium (e.g., the memory 130 of FIG. 1) that is readable by a machine (e.g., a device for generating 3D mesh data). For example, a processor (e.g., the processor 140) of the machine (e.g., the device 100 for generating 3D mesh data) may invoke at least one of the one or more instructions stored in the storage medium and execute the at least one invoked instruction. This allows the machine to be operated to perform at least one function in accordance with the at least one invoked instruction. The one or more instructions may include code generated by a compiler or code executable by an interpreter. The machine-readable storage medium may be provided in the form of a non-transitory storage medium. Here, the term “non-transitory” simply means that the storage medium is a tangible device, and does not include a signal (e.g., an electromagnetic wave), but this term does not distinguish between a case where data is semi-permanently stored in the storage medium and a case where data is temporarily stored in the storage medium.

According to an exemplary embodiment, a method according to various embodiments disclosed in the present document may be included and provided in a computer program product. The computer program product may be traded as a product between a seller and a buyer. The computer program product may be distributed in the form of a machine-readable storage medium (e.g., a compact disc (CD)-ROM) or distributed (e.g., downloaded or uploaded) online via an application store (e.g., PlayStore^{TM}) or directly between two user devices (e.g., smartphones). When the computer program product is distributed online, at least a part of the computer program product may be temporarily generated or at least temporarily stored in the machine-readable storage medium, such as memory of the manufacturer’s server, a server of the application store, or a relay server.

Components according to various embodiments of the present document may be implemented in the form of software or hardware such as a digital signal processor (DSP), an FPGA, or an ASIC, and perform certain roles. Components are not limited to software or hardware, and each component may be configured to reside in an addressable storage medium or run on one or more processors. As an example, components may include components such as software components, object-oriented software components, class components, and task components, processes, functions, attributes, procedures, subroutines, segments of program code, drivers, firmware, microcode, circuitry, data, databases, data structures, tables, arrays, and variables.

According to various embodiments, each of the above-described components (e.g., modules or programs) may include a single entity or a plurality of entities. According to various embodiments, one or more of the above-described components or operations may be omitted, or one or more other components or operations may be added. Alternatively or additionally, a plurality of components (e.g., modules or programs) may be integrated into a single component. In this case, the integrated component may still perform one or more functions of each of the plurality of components in the same or similar manner as they are performed by the corresponding one of the plurality of components before the integration. According to various embodiments, operations performed by a module, a program, or another component may be carried out sequentially, in parallel, repeatedly, or heuristically, at least one of the operations may be executed in a different order or omitted, or one or more other operations may be added.

According to various embodiments disclosed in the present document, from DSM 3D mesh data in which features are not distinguishable, it is possible to generate 3D mesh data in which individual buildings are separated such that features are distinguishable. In addition, various effects that are directly or indirectly found in the present document can be provided.

What is claimed is:

1. A device for generating three-dimensional (3D) mesh data, comprising:
a memory storing digital surface module (DSM) 3D mesh data; and
a processor functionally connected to the memory,
wherein the processor detects a bottom surface of each individual building using a height value in the DSM 3D mesh data, generates 3D mesh data of the individual building on the basis of a 3D space corresponding to the bottom surface, and stores the 3D mesh data of the individual building in the memory.

2. The device of claim 1, wherein the processor detects a minimum height value in the DSM 3D mesh data and increases a height value of a horizontal plane which is parallel to a horizon, stage by stage from the detected minimum height value to detect a plane acquired by connecting four or more vertices that are in the horizontal plane and have height values within a margin of error as the bottom surface of the individual building.

3. The device of claim 2, wherein the processor determines a lowest height value among vertex coordinate values of all triangles constituting the DSM 3D mesh data as the minimum height value.

4. The device of claim 2, wherein the memory stores outer-line information of the individual building, and
the processor verifies a position of the individual building using the outer-line information and detects the bottom surface of the individual building including the
plane acquired by connecting the four or more vertices at the verified position.

5. The device of claim 2, wherein, when the plane acquired by connecting the four or more vertices is detected, the processor calculates an area of the detected
plane, determines whether the calculated area is a threshold area or more, and when the calculated area is the threshold area or more, determines the detected
plane as the bottom surface of the individual building.

6. The device of claim 1, wherein the processor generates polygonal side surfaces from edges of the bottom surface and detects a 3D space surrounded by the
polygonal side surfaces and the bottom surface.

7. The device of claim 1, wherein the processor expands the bottom surface outward by a threshold distance, generates polygonal side surfaces perpendicular to a
horizon from edges of the expanded bottom surface, and detects a 3D space of the individual building including the polygonal side surfaces and the expanded
bottom surface.

8. The device of claim 1, wherein the processor selects triangles included in a 3D space of the individual building and generates the 3D mesh data of the individual building by configuring the selected triangles.

9. The device of claim 1, wherein, when the 3D mesh data of the individual building is generated, the processor separates the mesh data of the individual building from the DSM 3D mesh data to detect a remaining part of the DSM 3D mesh data, connects surfaces adjacent to the bottom surface in the remaining part to generate remaining DSM 3D mesh data from which the individual building is separated, and stores the remaining DSM 3D mesh data in the memory.

10. The device of claim 1, wherein the processor stores bottom surface detection history information of individual buildings in the memory while sequentially separating the individual buildings, and when a bottom surface of another building is detected at a position where the bottom surface is detected, determines that the previously generated 3D mesh data of the individual building is erroneous and generates the determined 3D mesh data of the individual building again.

11. A method of generating three-dimensional (3D) mesh data using at least one processor, the method comprising:
detecting a bottom surface of each individual building using a height value of digital surface model (DSM) 3D mesh data;
detecting a 3D space of the individual building including the bottom surface and side surfaces perpendicular to the bottom surface;
generating 3D mesh data of the individual building on the basis of the 3D space; and
storing the 3D mesh data of the individual building.

12. The method of claim 11, wherein the detecting of the bottom surface comprises:
detecting a minimum height value in the DSM 3D mesh data;
raising a horizontal plane which is parallel to a horizon, stage by stage from the detected minimum height value to detect a plane acquired by connecting four or more vertices that are in the horizontal plane; and
detecting the bottom surface of the individual building using the detected plane.

13. The method of claim 12, wherein the detecting of the bottom surface comprises:
determining a position of the individual building using outer-line information of the individual building; and
detecting the bottom surface of the individual building including the plane acquired by connecting the four or more vertices at the determined position.

14. The method of claim 12, wherein the detecting of the bottom surface further comprises repeating gradually raising the horizontal plane stage by stage up to a maximum height value in the 3D mesh data to generate the 3D mesh data of the individual building from the 3D mesh data.

15. The method of claim 12, wherein the detecting of the bottom surface of the individual building comprises:
when the plane acquired by connecting the four or more vertices are detected, calculating an area of the detected plane;
determining whether the calculated area is a threshold area or more; and
when the calculated area is the threshold area or more, determining the detected plane as the bottom surface of the individual building.

16. The method of claim 11, wherein the detecting of the 3D space comprises:
expanding the bottom surface outward by a threshold distance;
generating polygonal side surfaces perpendicular to the horizon from edges of the expanded bottom surface; and
detecting the 3D space of the individual building surrounded by the polygonal side surfaces and the bottom surface.

17. The method of claim 11, wherein the generating of the 3D mesh data comprises:
selecting triangles included in the 3D space of the individual building; and
generating the 3D mesh data of the individual building by configuring the selected triangles.

18. The method of claim 11, further comprising;
when the mesh data of the individual building is generated, separating the mesh data of the individual building from the DSM 3D mesh data to detect a remaining part of the DSM 3D mesh data;
connecting surfaces adjacent to the bottom surface in the remaining part to generate remaining DSM 3D mesh data from which the individual building is separated; and
storing the remaining DSM 3D mesh data.

19. The method of claim 11, further comprising:
sequentially separating individual buildings to store bottom surface detection history information of the individual buildings;
when a bottom surface of another building is detected at a position where the bottom surface is detected, determining that the previously generated 3D mesh data of the individual building is erroneous; and
generating the determined 3D mesh data of the individual building again.

20. A device for generating three-dimensional (3D) mesh data, comprising:
a communication module configured to communicate with a user terminal; and
a processor functionally connected to the communication module,
wherein the processor acquires digital surface model (DSM) three-dimensional (3D) mesh data through the communication module in accordance with a request of the user terminal,
detects a bottom surface of each individual building using a height value in the DSM 3D mesh data,
detects a 3D space of the individual building including the bottom surface and side surfaces perpendicular to the bottom surface and generates 3D mesh data of the individual building on the basis of the 3D space, and
provides the 3D mesh data of the individual building to the user terminal through the communication module.
